(19) United States
(12) Patent Application Publication
(10) Pub. No.: US 2011/0292420 A1
(43) Pub. Date: Dec. 1, 2011

(54) SYSTEM AND METHOD FOR CREATING ART PIECE

(76) Inventors: JEFF DUNGAN, Birmingham, AL (US); CHAD MARTIN, Vestavia, AL (US); LOUIS NEQUETTE, Birmingham, AL (US)

(21) Appl. No.: 13/115,802

(22) Filed: May 25, 2011

Related U.S. Application Data
(60) Provisional application No. 61/347,980, filed on May 25, 2010.

(51) Int. Cl. G06K 9/36; G06F 15/00

(52) U.S. Cl. 358/1.9; 382/284

(57) ABSTRACT

A multi-step, computer-based process for creating a stylized art piece using collage and layering techniques. The process comprises acquiring and arranging high resolution digital images or photographs to form a gestalt or single cohesive piece using a computer. These images or photographs may involve sporting events, players, participants, areas of play, and related subjects. When arranged, the images or photographs may be overlapped, blended or merged in whole or in part. Digital processing techniques are used to make some or all of the images and photographs look older or aged. Several layers of diagrams or text are added. The piece is then printed on canvas, paper or other suitable material using the Giclee' printing process. The print is mounted on a frame, and then covered with one or more layers of a clear or translucent coating or over-laminate.

This application claims benefit of and priority to U.S. Provisional Application No. 61/347,980, filed May 25, 2010, and is entitled to that filing date for priority. The specification, figures and complete disclosure of U.S. Provisional Application No. 61/347,980 are incorporated herein by specific reference for all purposes.

### FIELD OF INVENTION

This invention relates to a system and method for creating a stylized art piece from several elements.

### SUMMARY OF INVENTION

In various embodiments, the present invention comprises a multi-step, computer-based process for creating a stylized art piece using collage and layering techniques. In one embodiment, the process begins with acquiring and arranging high resolution digital images or photographs to form a gestalt or single cohesive piece using a computer. These images or photographs may involve sporting events, players, participants, areas of play, and related subjects. Any number of images or photographs may be used; in one embodiment, at least three to five images or photographs are used to create the piece.

When arranged, the images or photographs may be overlapped, blended or merged in whole or in part in the computer using Photoshop and other software programs. The process then uses digital processing techniques to make some or all of the images and photographs look older or aged. This may be accomplished through selective adjustment of tone or color and using computer “filters” and other techniques.

Next, several layers of diagrams or text are added. The diagrams may be hand-drawn or hand-written, and the text may be descriptive or inspirational, and may comprise dates, names, title, quotes, or the like. This results in the final art piece in digital form. The piece is then printed on canvas, paper or other suitable material using the Giclee' printing process. The Giclee' process is the process of making high-resolution fine art prints or reproductions from a digital source using an ink-jet printer or special large format printer (or similar printer). The printed canvas is then wrapped onto a frame, which may be wood or similar material. The printed canvas is then covered with a clear or translucent coating or over-laminate, such as Endura Coat Giclee Satin, which may be hand-applied. Multiple coating may be applied on the canvas, in whole or in part.

### DESCRIPTION OF THE DRAWINGS

FIG. 1 is a diagram of one exemplary embodiment of the present invention.

FIG. 2 shows an exemplary art piece created in accordance with an exemplary embodiment of the method described herein.

FIG. 3 shows another exemplary art piece created in accordance with an exemplary embodiment of the method described herein.

### DETAILED DESCRIPTION OF EXEMPLARY EMBODIMENTS

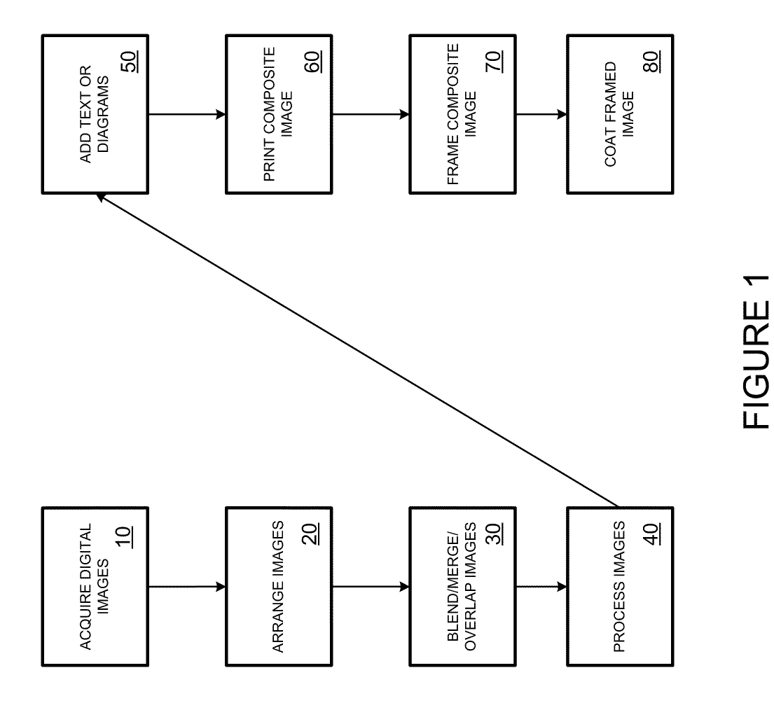

In one exemplary embodiment, the present invention comprises a multi-step, computer-based process for creating a stylized art piece using collage and layering techniques. As seen in FIG. 1, the process begins with acquiring 10 and arranging 20 high resolution digital images or photographs to form a gestalt or single cohesive piece using a computer. In one embodiment, these images or photographs may involve sporting events, players, participants, areas of play, and related subjects. Any number of images or photographs may be used; in one embodiment, at least three to five images or photographs are used to create the piece. When arranged, the images or photographs may be overlapped, blended or merged 30 in whole or in part in the computer using Photoshop and other software programs. The process then uses digital processing techniques to make some or all of the images and photographs look older or aged 40. This may be accomplished through selective adjustment of tone or color and using computer “filters” and other techniques.

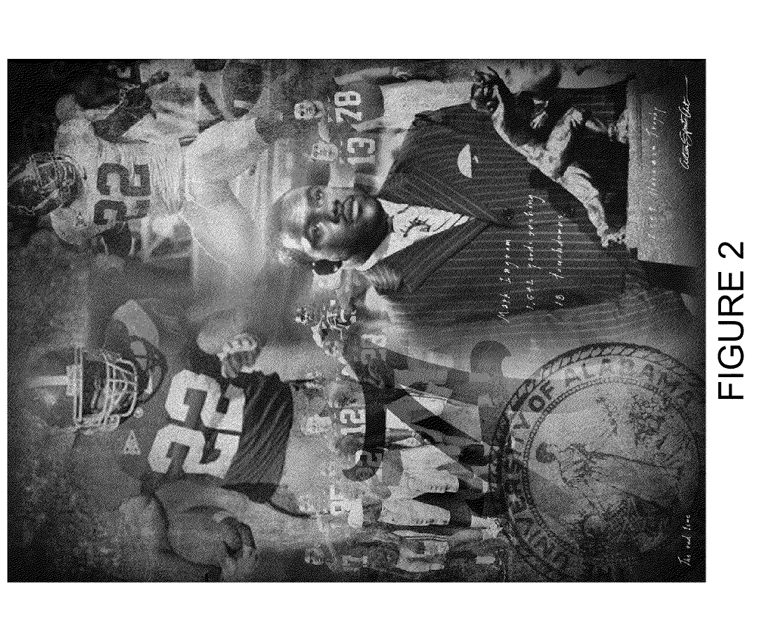

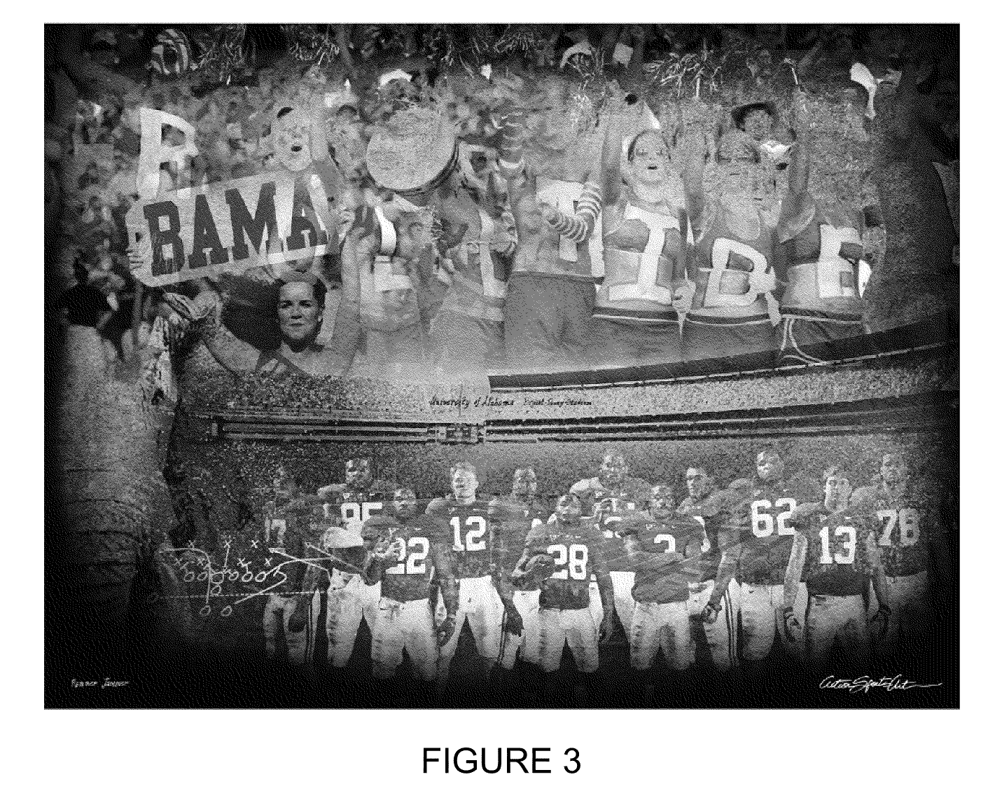

Next, several layers of diagrams or text are added 50. The diagrams may be hand-drawn or hand-written, and the text may be descriptive or inspirational, and may comprise dates, names, title, quotes, or the like. This results in the final art piece in digital form (as seen in FIGS. 2 and 3).

The piece is then printed 60 on canvas, paper or other suitable material. In one embodiment, printing is accomplished using the Giclee' printing process. The Giclee' process is the process of making high-resolution fine art prints or reproductions from a digital source using an ink-jet printer or special large format printer (or similar printer) such as EFI/Vutek 3360 Solvent.

The printed canvas is then wrapped onto a frame 70, which may be wood or similar material. The printed canvas is then covered with a clear or translucent coating or over-laminate 80, such as Endura Coat Giclee Satin, which may be hand-applied. Multiple coating may be applied on the canvas, in whole or in part.

In order to provide a context for the various aspects of the invention, the following discussion provides a brief, general description of a suitable computing environment in which several of the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method of creating an art piece, comprising the steps of:
acquiring two or more high resolution images or photographs in digital format;
arranging, using a microprocessor or processor, the images together;
blending, merging or overlapping the images in whole or in part to form a composite image;
processing the composite image, using a microprocessor or processor, with digital processing techniques; and
adding, using a microprocessor or processor, one or more layers of diagrams or text to the composite image.

2. The method of claim 1, wherein the step of processing the composite image makes some or all of the images in the composite image look older or aged.

3. The method of claim 1, wherein the diagrams or text comprise dates, names, quotes, titles, or descriptive or inspirational text.

4. The method of claim 1, further comprising the steps of:
printing the resulting composite image; and
mounting or wrapping the printed composite image on a frame.

5. The method of claim 4, wherein the step of printing uses the Giclee' printing process.

6. The method of claim 4, further comprising the step of applying one or more clear or translucent coating to the printed composite image.
